(19) United States
(12) Patent Application Publication
(10) Pub. No.: US 2015/0093001 A1
(43) Pub. Date: Apr. 2, 2015

(54) IMAGE SEGMENTATION SYSTEM AND OPERATING METHOD THEREOF

(71) Applicant: National Taiwan University of Science and Technology, Taipei (TW)

(72) Inventor: Ching-Wei WANG, Taipei (TW)

(73) Assignee: National Taiwan University of Science and Technology, Taipei (TW)

(21) Appl. No.: 14/042,003

(22) Filed: Sep. 30, 2013

(51) Int. Cl. G06T 7/00; G06K 9/62

(52) U.S. Cl. CPC G06T 7/0012; G06K 9/6267; G06T 2207/30048
USPC 382/131

(57) ABSTRACT

An image segmentation system for performing image segmentation on an image data includes an image preprocessing module, a motion analyzing module, a detection module, a classification module, and a multi-dimensional detection module. The image data has a plurality of image stacks ordered chronologically that respectively have a plurality of images sequentially ordered according to spatial levels, wherein one spatial level is designated as a first stack. The image preprocessing module transforms the images into binary images while the motion analyzing module finds a repeating pattern in the binary images in the first stack and accordingly generates a repeating motion result. The classification module generates a classification result based on a spatial and an anatomical assumption to classify objects. The multi-dimensional detection module generates segmentation results for stacks above and below the first stack using spatial and temporal consistency of geometric layouts of object structures.

### BACKGROUND OF THE INVENTION

1. Field of the Invention

The present invention generally relates to an image segmentation system and operating method thereof; particularly, the present invention relates to a 4D cardiac image segmentation system and operating method thereof that can automatically and accurately detect left and right heart ventricular structures from cardiac images.

2. Description of the Related Art

When medical scanners such as MRI (Magnetic Resonance Imaging) technologies first appeared on the market, the medical industry was enthused to have such a powerful tool to aid in the diagnostic of diseases and illnesses. MRI scanners work by scanning a subject numerous times to produce a plurality of images representing a series of cross-sections of the subject. When the images are placed in order in a stack, the images form a three-dimensional view of the subject. This is particularly useful to medical personal since an internal view of the subject would be allowed without invasive surgery. For instance, in terms of cardiac cases, evaluation of the right and left ventricular structures and functions thereof is of importance in the management of most cardiac disorders. However, the quality of images taken (especially on live moving subjects), as well as variations in size and shapes of organs in different subjects make Magnetic Resonance images difficult to work with without manual confirmation of the images by a medical specialist. As a result, automatic segmentation of the right and left ventricular structures in Magnetic Resonance images (MRI) is difficult, involving complex problems such as dealing with the highly variable, crescent shape of the right ventricle and its thin and ill-defined borders. This not only results in more errors in judgment in diagnosis of the patient illness, but it also increases the amount of manual work that medical specialists have to perform, which is counter conducive to efficient and effective data management for easy diagnosis of illnesses.

### SUMMARY OF THE INVENTION

It is an objective of the present invention to provide an image segmentation system and operating method thereof that can automatically perform image segmentation to detect and identify structures from medical images.

It is another objective of the present invention to provide an image segmentation system and operating method thereof that can increase the accuracy and efficiency of automatic image segmentation to identify effectively structures from medical images.

The image segmentation system for segmenting image data having a plurality of image stacks ordered according to their respective spatial levels includes an image preprocessing module, a motion analyzing module, a detection module, a classification module, and a multi-dimensional detection module. One image stack of the plurality of image stacks is designated as a first stack and each image stack has a plurality of images that are chronologically ordered. The image preprocessing module transforms the images respectively into binary images. The motion analyzing module generates a repeating motion result based on a repeating motion pattern of the binary images in the first stack. The detection module generates a detection result based on the repeating motion result and the binary images of the first stack. The classification module generates a classification result based on spatial assumptions and anatomical assumptions. The multi-dimensional detection module generate detection results over the stacks above and below the first stack using spatial and temporal consistency of geometric layouts of object structures.

The operating method of the image segmentation system includes: (A) designating in an image preprocessing module an image stack from the plurality of image stacks as a first stack; (B) transforming in the image preprocessing module the images for all stacks into binary images and generating object maps by detecting connected objects in the binary images; (C) analyzing in a motion analyzing module for a repeating motion pattern in the binary images and accordingly generating a repeating motion result; (D) generating in a detection module a detection result of the first stack based on a frequency level of the repeating motion occurring within individual objects; (E) generating in a classification module a classification result based on a spatial assumption and an anatomical assumption to classify the objects; (F) generating segmentation results in a multi-dimensional detection module for the image stacks above and below the first stack according to spatial and temporal consistency of geometric layouts of the objects.

### BRIEF DESCRIPTION OF THE DRAWINGS

FIG. 1A is an embodiment of a framework of the present invention;

FIG. 1B is an embodiment of the image segmentation system;

FIG. 2A is an embodiment of the relationship between the heart and an image stack of the present invention;

FIG. 2B is an embodiment of the database having a plurality of image stacks;

FIGS. 3A and 3B are embodiments of the various transformations that the images of the image stack undergo in the image segmentation system;

FIG. 3C is an embodiment of images of the image stack being transformed into binary images;

FIG. 3D is an embodiment of generating the motion pattern images from the binary images;

FIG. 3E is an embodiment of generating the detection result by computing the frequency of the repeating motion patterns within individual objects over the connected object map derived from a binary image;

FIG. 4 is an embodiment of the plurality of image stack structure; and

FIG. 5 is a flowchart diagram of the operating method of the image segmentation system.

### DETAILED DESCRIPTION OF THE PREFERRED EMBODIMENT

Evaluation of ventricular structure of the heart and function thereof is of great importance in the management of most cardiac disorders, such as pulmonary hypertension, coronary heart disease, dysplasia, and cardiomyopathies. Whereas some relatively efficacious methods are commercially available for segmenting the left ventricle on magnetic resonance images (MRI), segmentation on the right ventricle has mostly failed, hampered by (i) fuzziness of the cavity borders due to blood flow and partial volume effect, (ii) the presence of trabeculations (wall irregularities) in the cavity, which have the same grey level as the surrounding myocardium, (iii) the complex crescent shape of the right ventricle (RV), which varies according to the imaging spatial (slice) level.

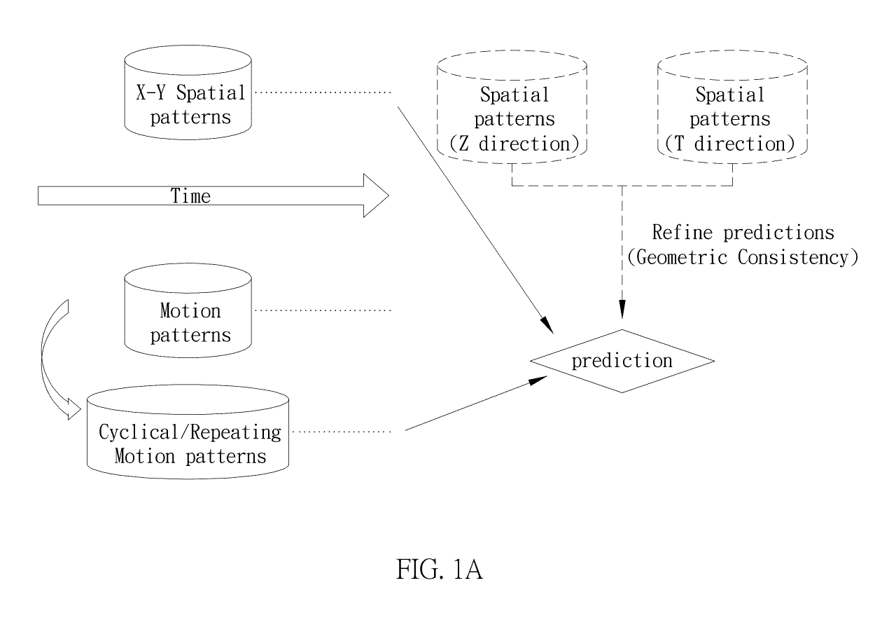

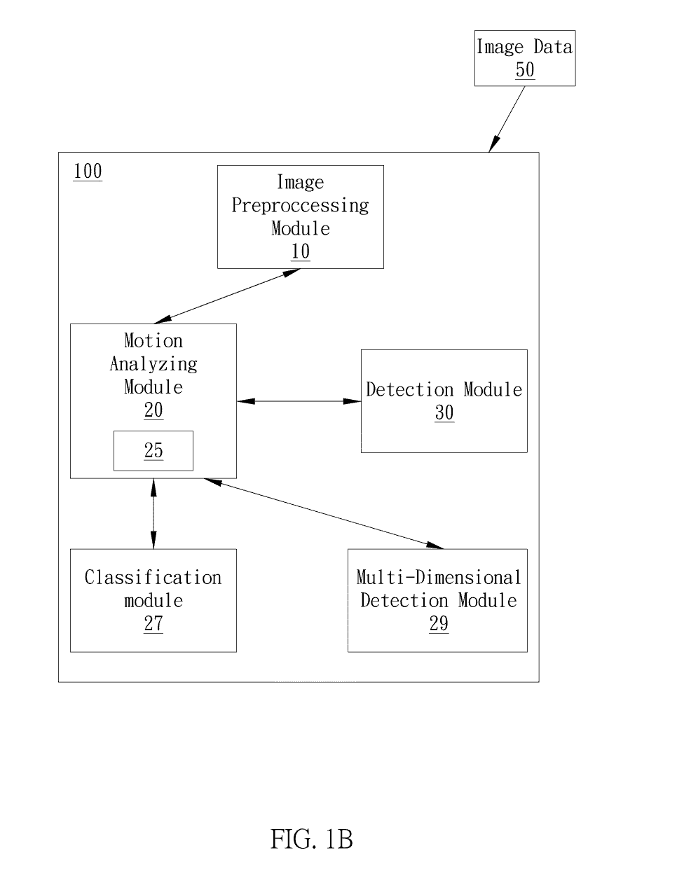

FIG. 1A is a diagram of a system framework detailing the basic idea behind the present invention. The present invention looks for any spatial patterns in slide images (ex. from MRI) as well as any repeating motion patterns from those consecutive slide images. The system utilizes the information in order to refine the prediction of the spatial patterns such that different structural components in the slide images may be more accurately identified. In a preferred embodiment, the present invention provides a fully automatic and unsupervised segmentation method based on the cyclical motion of the heart. It combines the spatial morphological patterns in X-Y directions and the temporal cyclical (repeating) cardiac motion patterns to find the endocardium contour of the right ventricle from 4D cardiac MRI data. In an embodiment, a coarse left ventricle (LV) detection which searches for connected objects with repeating movements and square-like bounding box is developed to filter out detected objects with cyclical cardiac motion. The coarse LV detection is firstly applied to the middle image spatial (slice) level of the image stack, wherein the middle image (slice) spatial levels are observed to consistently contain LV and RV with bigger size in comparison to other image (slice) spatial levels. For the RV and LV segmentation application, the segmentation complexity depends on the stack level of the long axis (over Z direction), and it is more difficult to segment the apical and basal stack images than mid-stack ventricular images, which is because that at the apex, neither RV structure nor LV structure is distinctive and that ventricle shapes are strongly modified close to the base of the heart due to the vicinity of the atria. Next, detected LVs are utilized to find LVs in other stacks. Connected objects with repeating movements and high overlap ratio between itself and the detected LV in the neighboring stack are identified. Similarly, RV detection is applied firstly to the middle image spatial (slice) level to search for bigger connected objects with repeating movements but excluding the detected LVs. Then, using the detected RVs, geometric constraints over Z direction are generated, and RVs are detected by searching for objects with repeating motion, low overlap ratio with detected LVs and high overlap ration with detected RVs in the neighboring images.

In order to realize the framework shown in FIG. 1A, the present invention provides an image segmentation system 100, as shown in an embodiment in FIG. 1B. Image segmentation system 100 includes an image preprocessing module 10, a motion analyzing module 20, and a detection module 30. In the present embodiment, image segmentation system 100 receives image data having a plurality of image stacks. In the present embodiment, in order to facilitate better understanding of the present invention, the image data may be viewed as being stored in a database 50, wherein the database 50 may be a database that is external to the image segmentation system 100 or may be an integral component of the image segmentation system 100. In other embodiments, the image segmentation system 100 may also include a classification module 27 and a multi-dimensional detection module 29. The classification module 27 and the multi-dimensional detection module 29 may be coupled to the motion analyzing module 20 as integral or separate components.

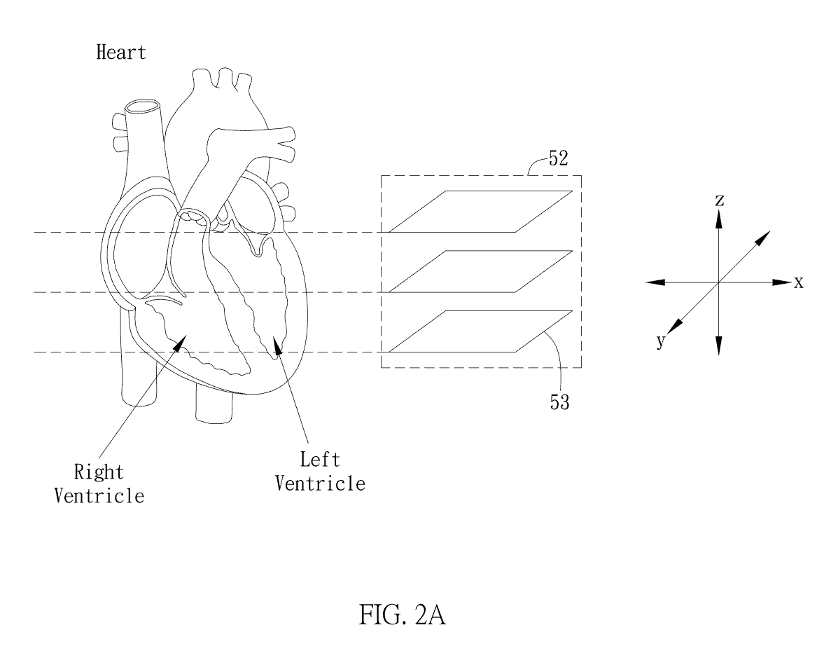

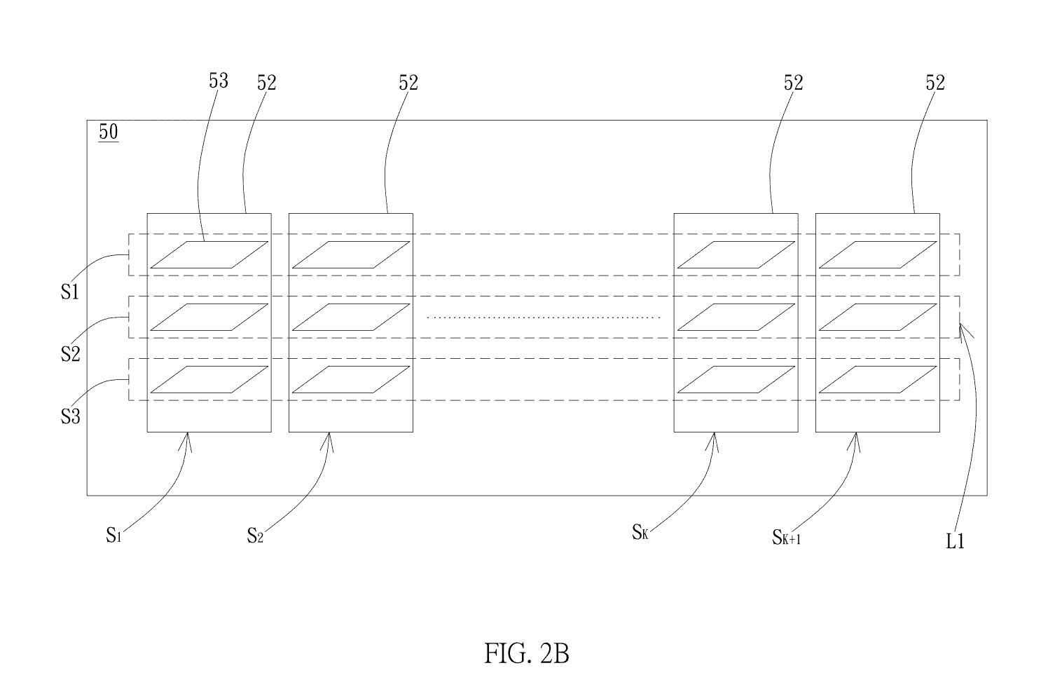

FIG. 2A illustrates how a medical scan is initiated on an object. In the present embodiment, the image segmentation system 100 is preferably utilized for segmenting raw image data from magnetic resonance imaging (MRI) devices. As shown in FIG. 2A, the raw images 53 are preferably cross-sectional (slide) images in the X-Y plane of the object. For example, in the present embodiment, the object may be a heart. However, in other different embodiments, the object may be the lungs or anything else of interest. Conventionally, the MRI device scans a plurality of the cross-sectional images at different X-Y planes along the Z-direction to produce a plurality of images grouped together to form a 3D object scan 52. In this manner, each 3D object scan 52 has a plurality of images that are ordered according to their spatial levels corresponding to the different X-Y planes that they were scanned (as can be seen in FIG. 2A where each 3D object scan 52 contains a plurality of raw images 53). That is, the 3D object scan 52 represents a series of cross-sectional scans of the heart at a particular point in time. In this manner, through the plurality of images 53, a general three-dimensional view of the heart may be obtained. As the MRI scans are taken at different points in time, the image segmentation system 100 will receive a plurality of 3D object scans 52. As shown in FIGS. 2A and 2B, each raw image 53 of each 3D object scan 52 corresponds to a X-Y scan level (spatial level). Raw images 53 having the same spatial level are grouped together in the same image stacks. That is, the raw image stacks can contain a plurality of raw images that are chronologically ordered. Therefore, a four-dimensional view of the heart may be obtained with a number of 3D object scans ordered over time. For example, if each 3D object scan 52 contained 3 raw images 53, there would be 3 image stacks S1, S2, and S3, wherein S₁ to S_{K+1} would represent the different 3D object scans 52 ordered in chronological order. In the present embodiment, the image segmentation system 100 receives the plurality of 3D image scans 52 from the MRI device as a series of the raw images 53. According to a default setting for the number of images per image stack, the image segmentation system 100 can recognize from the series of raw images that it receives which images belong to which image stack. For instance, if the default setting was 4 images per 3D image scans 52, and if the image segmentation system 100 received 12 images ordered in a series as the image data, the image segmentation system 100 would recognize that the first 4 images would be the first 3D image scans 52, the next 4 images would be the second 3D image scans 52, the last four images would be the third 3D image scans 52.

FIG. 2B illustrates an embodiment of the image data 50. In order to facilitate better understanding of the present invention, the image data 50 in FIG. 2B is illustrated with the images already organized in image stack form. As shown in FIG. 2B, each 3D image scans 52 is composed of a plurality of (raw) images 53 that are sequentially ordered according to their spatial levels. In the present embodiment, as mentioned above, each of the 3D image scans 52 represents a three-dimensional magnetic resonance data of a cardiac structure (heart). 3D image scans 52 are ordered chronologically in the order that they were generated such that, in essence, the image data 50 represents a series of three-dimensional image data taken over a duration of time (ie. 4D Magnetic Resonance Image data). As mentioned, the plurality of images 53 making up each 3D image scans 52 represents cross-sectional scans or slide images of the object of interest. In terms of performing MRI scans on the heart, MRI scans are conventionally performed on the heart in the X-Y plane at various spatial levels along the Z direction such that the plurality of the images 53 can make up the 3D image scans 52 at a particular point in time. These cross-sectional image (slide) scans (ie. images 53) are ordered sequentially in the 3D image scans 52 according to the position their scans took place on the heart. In other words, if the MRI scans were performed at three X-Y planes on the heart in the order from top to bottom, the respective 3D image scans 52 would have three slide images ordered in the same order of the scans from top to bottom.

As shown in FIG. 2B, in the present embodiment the plurality of images 53 in a single 3D image scan 52 forms a three-dimensional view of the heart. For example, as shown in FIG. 2B, the 3D image scans 52 labeled as S₁ represents a three-dimensional view on the object (in this case, the heart) at time equals 1. In comparison to the 3D image scans 52 of S₁, the heart may have moved in the time that the MRI device once again performed image scans on the heart. As such, the 3D image scans 52 of S₁ and the 3D image scans 52 of S₂ may have slight variations in the spatial patterns of their images 53 due to the heart's movements. Preferably, each 3D image scan 52 in the database 50 has the same amount of images 53. In this manner, each image 53 of each 3D image scans 52 would correspond to a particular spatial level (such as S1-S3). For instance, in an image data 50 with 3D image scans 52 that have 3 images 53 each, since the images 53 of each 3D image scans 52 are ordered spatially accordingly to how they were scanned by the MRI machine, the images 53 at the top of each 3D image scans 52 would correspond to the top spatial level. Conversely, the middle images and the bottom images of each 3D image scans 52 would respectively correspond to the middle and bottom spatial levels. Images 53 corresponding to the same spatial level are grouped together in the same image stack. For instance, as shown in FIG. 2B, the images 53 in the top spatial level are grouped in the image stack S1.

As shown in FIGS. 1B and 2B, in the present embodiment the image preprocessing module 10 of the segmentation system 100 will receive the images 53 in each 3D image scans 52 that correspond to a particular spatial level (ie. images corresponding to a particular image stack). Preferably, the image preprocessing module 10 has a default setting to select which spatial level (or image stack) of images 53 it may request to receive from the database 50. Since the left and right ventricle structures of the heart are most pronounced in the cross-sectional slide images originating from the middle of the 3D image scans 52 (where the width of the heart is at its widest and the structural shapes are most prominent), the default setting would preferably be set to a spatial level corresponding to an image from the middle of the 3D image scans 52. In this manner, the initial image analysis and segmentation conducted by the segmentation system 100 may be performed on images 53 in the image stack that has the highest rate of success for determining the left and right ventricular structures. In the present embodiment, the middle spatial level of the 3D image scans 52 in the image data 50 is designated as the first image stack L1 to represent that the images 53 of this particular spatial level (ie. image stack) will be the first spatial level to be processed and analyzed by the image segmentation system 100. It should be noted, however, that the three spatial levels in FIG. 2B is for illustrative purposes only in order to better facilitate understanding of the present invention. That is, the number of spatial levels in the 3D image scans 52 is not restricted to only 3 spatial levels, but may be a plurality of spatial levels (ie. image data 50 may have a plurality of image stacks).

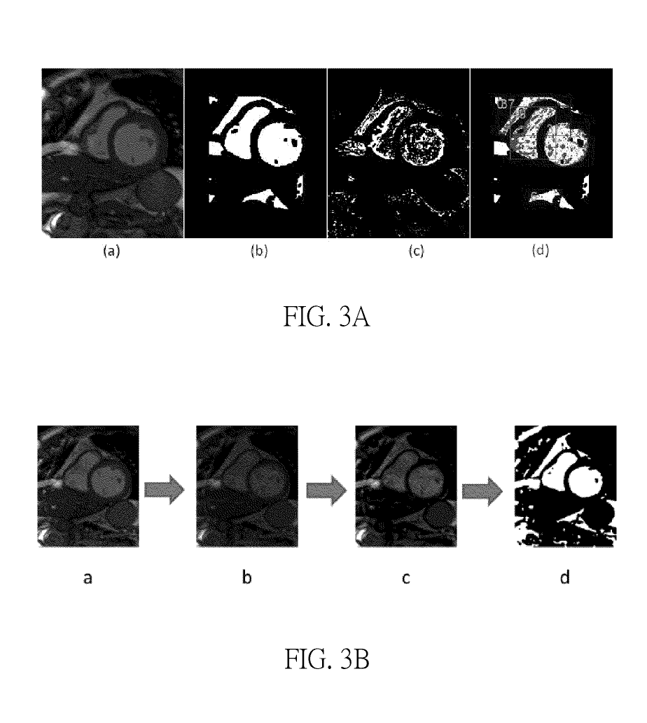

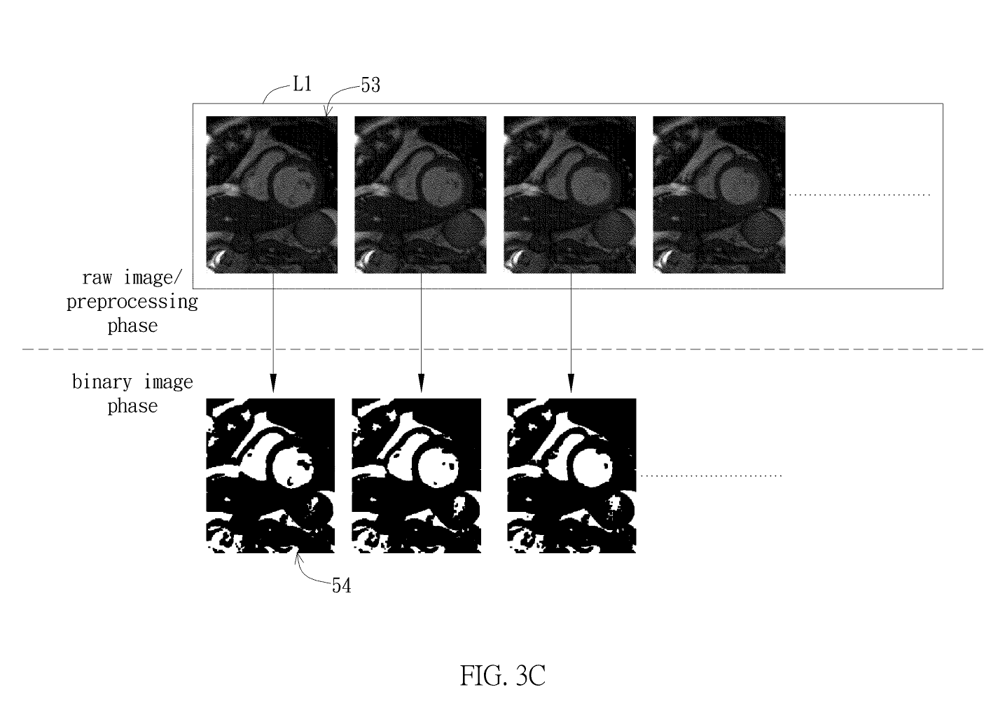

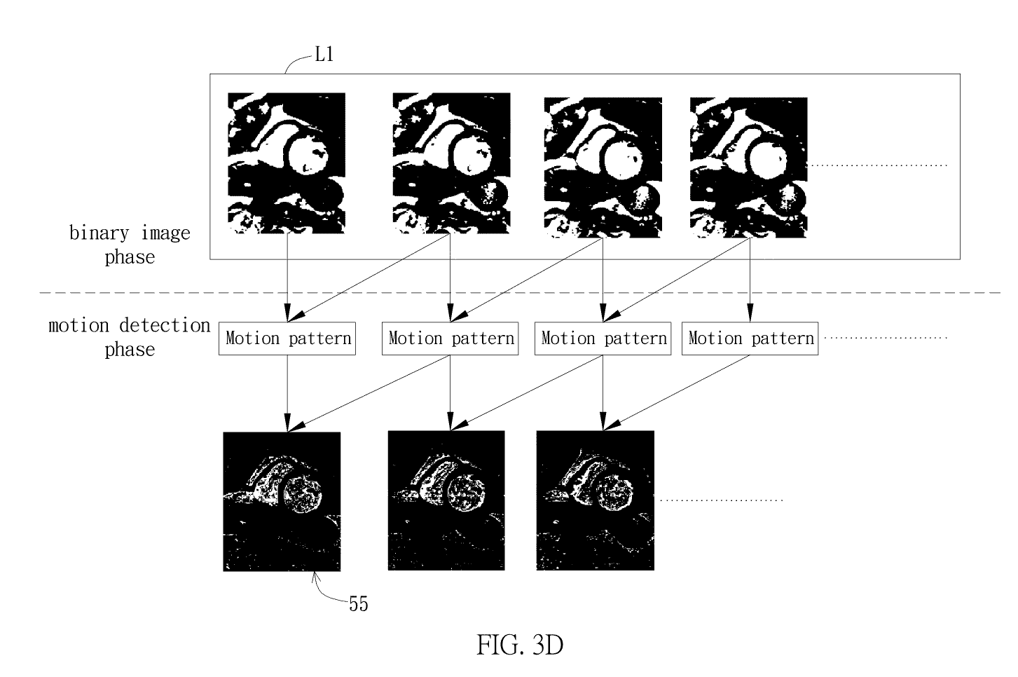

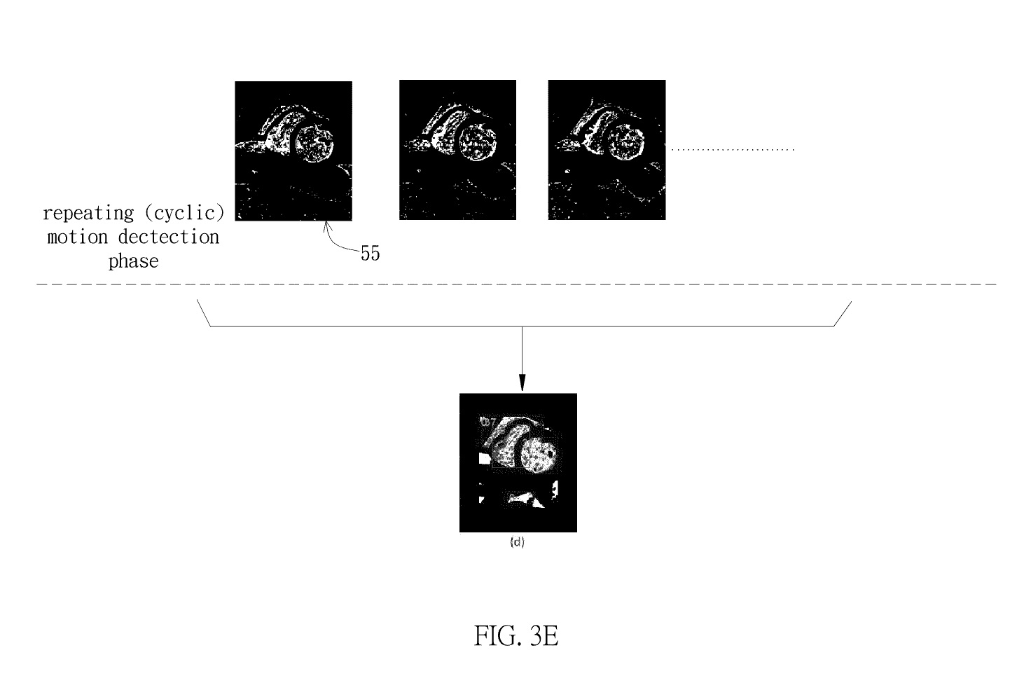

As shown in FIGS. 1B and 2B, when the image preprocessing module 10 receives the requested first image stack L1 (images having the same spatial level) of images 53 from the image data 50, the image preprocessing module 10 will first transform the images 53 it receives into binary images. As shown in an exemplary embodiment in FIG. 3B, there may be multiple stages involved in transforming the images (as seen in figure a of FIG. 3B) to the binary image (as seen in figure d of FIG. 3B). The image preprocessing module 10 may employ image contrasting, sharpening, or any other combination of image processing to transform the images 53 into the binary images. In this manner, as shown in FIGS. 3A and 3B, the images 53 in figure (a) of FIG. 3A may be simplified to the binary image in figure (b) so that the amount of data needed to be subsequently analyzed by the motion analyzing module 20 may be reduced.

FIG. 3C illustrates how each image 53 in the image stack L1 is transformed into their respective binary images 54. After the images 53 are converted into the binary images 54, the motion analyzing module 20 will further perform data analysis on the binary images. As shown in FIG. 1B, in the present embodiment, the motion analyzing module 20 may further include a spatial pattern detecting module 25 for recognizing structural (morphological) patterns in the binary images. However, in other different embodiments, the spatial pattern detecting module 25 may be an independent unit separate from the motion analyzing module 20. Preferably, the spatial pattern detecting module 25 runs a simplistic morphology-based algorithm that utilizes the layout, the shapes, the sizes, and the relative locations of discernible groups of pixels in the binary images to predict the locations of the left and/or right ventricle. That is, the spatial pattern detecting module 25 performs simplistic morphology pattern comparisons on the binary images in each 3D image scans 52 that correspond to the first level L1 (image stack) in order to preliminarily identify potential structures that could possibly be the left and/or right ventricle. The spatial pattern detecting module 25 then accordingly generates a recognition result based on this preliminary identification. For example, the spatial pattern detecting module 25 may circle or box the potential area or structure in the binary image to mark what it may think are groups of pixels that may potentially be the left and/or right ventricle. In the present embodiment, the spatial pattern detecting module 25 performs this for each binary image in the first level L1. However, in other different embodiments, the spatial pattern detecting module 25 can utilize the recognition result from the first binary image to more quickly identify the corresponding potential objects/locations in the subsequent binary images in the first level L1. In other words, the spatial pattern detecting module 25 may propagate the recognition result(s) derived from the first (spatial) level to the other spatial levels such that the left and/or right ventricular structures may be more easily, quickly, and accurately found in those other spatial levels by refining the predictions according to the recognition results found in previous spatial levels.

In the present embodiment, the recognition result is received by the motion analyzing module 20 along with the binary images that correspond to the first level L1 (image stack). The motion analyzing module 20 then compares the recognition results of each binary image in the first image stack L1 to detect or identify the movement or motion of each of the predicted potential left and/or right ventricle. In more definite terms, the motion analyzing module 20 utilizes the recognition results when comparing the consecutive binary images that correspond to the first image stack L1 to determine a reoccurring or repeating (motion) pattern in the movements, as shown in FIG. 3D. In terms of the heart, the motion analyzing module 20 is looking for a periodic and cyclical cycle of motion by the potential left and/or right ventricle (that was found by the spatial pattern detecting module 25) as the binary images of the first image stack L1 is analyzed in chronological order. Preferably, in the present embodiment, the motion analyzing module 20 utilizes the following formula to identify reoccurring or repeating motions:

T(x,y,t)=∩[r−1,i=0]M(x,y,t+i)

The motion analyzing module 20 looks for any repeating motion by focusing on the intersection of motion over time. In the above equation, r represents the specified length of the temporal window of motion since the beginning of action. The motion analyzing module 20 then generates a repeating motion result based on the analysis results of the repeating motion pattern. As shown in FIGS. 3A, 3D, and 3E, after analyzing the consecutive binary images (b) of the first image stack L1, the motion analyzing module 20 will have a repeating motion result similar to figure (c). The figure shown in figure (c) of FIG. 3A represents the pixels that have repeating motion across all the binary images in the first level L1.

The detection module 30 then fuses the static information of the predicted potential left/right ventricle objects (recognition results) with the dynamic information of the repeated motion patterns (repeating motion result) to refine and select the potential left/right ventricle object having the highest frequencies of repeated motion patterns as the main left/right ventricle of the cardiac magnetic resonance images. As shown in FIG. 3E, based on the recognition results and the repeating motion result, the detection module 30 generates a detection result and marks (boxing) the left and right ventricles.

In the present embodiment, the image segmentation system 100 can further isolate the left ventricle from the right ventricle. Based on the relative location, size, and shape, the detection module 30 can determine the rightmost potential object in the detection result to be the left ventricle of the heart (typically, the left ventricle will be a ball-like shape on the rightmost side of the binary image). After determining the left ventricle, based on the relative position, size, and shape, the right ventricle may be determined by subtracting the determined left ventricle from the detection result.

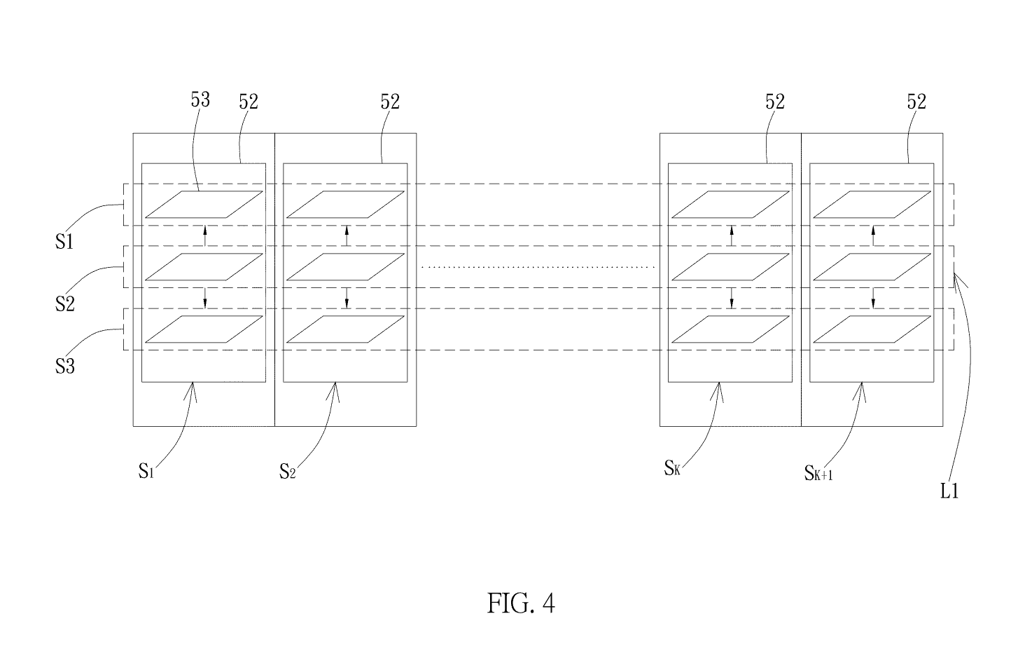

In the above processes, the image segmentation system 100 has only performed image segmentation processing on the first level L1 (image stack) to find the precise locations of the left and right ventricles. Preferably, after identifying the left and right ventricles in the first level L1, the image segmentation system 100 will then use these results to find the corresponding left and right ventricles in the other spatial levels (image stacks). As shown in FIG. 4, after the first level L1 has been processed, the results may be used to refine the prediction of the left and/or right ventricular structures in the above and/or below image stacks S1 or S3. For example, the locations of the left and right ventricles found after the image segmentation system 100 processed the first level L1 may be used as guidelines to find corresponding locations in the binary images corresponding to the images 53 that are directly above or below the first level L1 (image stack S2). The image segmentation system 100 can then once again process the images 53 in those spatial levels (image stacks) according to the process performed on the first level L1 in order to once again accurately identify the left and/or right ventricular structures. The above process may be perpetually repeated for subsequent image stacks that are below or above. In this manner, by the time the image segmentation system 100 reaches the bottom most or the upper most spatial level (image stacks), the left and right ventricular structures may still be accurately identified since their predicted locations correspond to the refined predictions found in the first level L1.

In other different embodiments, the spatial pattern detecting module 25 may include or be alternatively replaced by a classification module 27 and/or a multi-dimensional detection module 29. The classification module 27 generates a classification result based on spatial assumptions and anatomical assumptions of potential objects detected in the binary images. In the present embodiment, since the heart is the subject of interest, the spatial and anatomical assumptions will correlate with the structure, shape, size, related distances thereof of the heart. For instance, slide images in the X-Y plane of the heart will generally produce a left ventricle that is circular in shape, while the right ventricle will be generally known to be positioned beside the left ventricle. The multi-dimensional detection module 29 generates detection results for the stacks above and below the first image stack L1 by using spatial and temporal consistency of geometric layouts of object structures. For instance, since the spatial and anatomical assumptions correspond to the heart in the present embodiment, the multi-dimensional detection module 29 will use the detection results generated for the first level L1 (image stack) to refine or error-check the detection results of the image stacks that are subsequently above and/or below the first level (image stack) L1. In this manner, even as the shapes or sizes of the left and right ventricle become irregular, or that a particular binary image 54 has errors in it, the multi-dimensional detection module 29 would be able to correct these anomalies and still be able to produce correct detection results. As well, by using the detection results of prior image stacks, the detection results of subsequent image stacks may be found much more quickly with certainty.

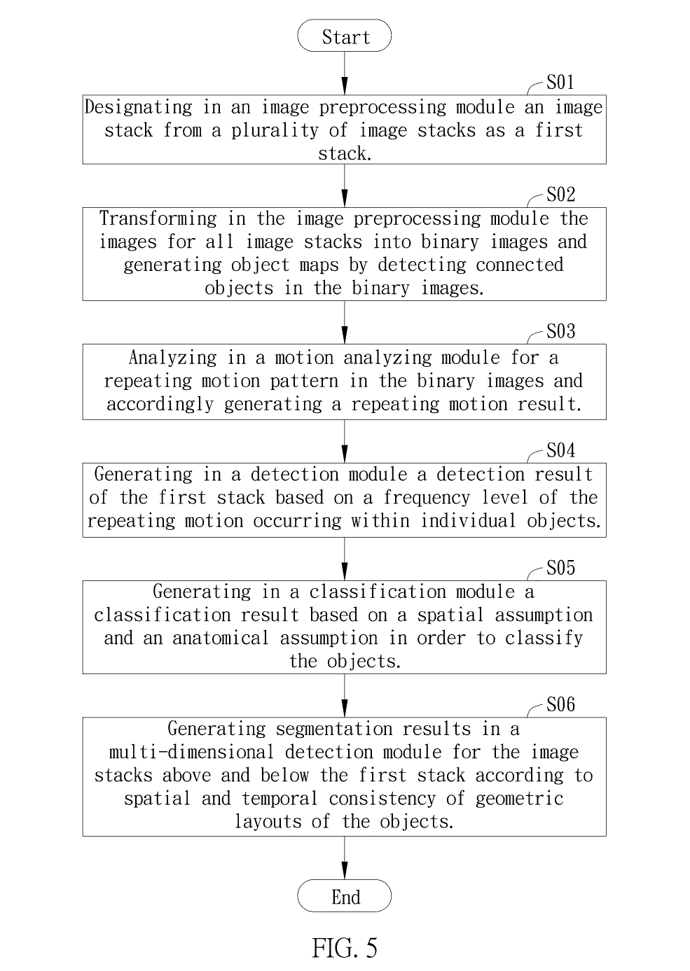

FIG. 5 is a flowchart diagram illustrating an embodiment of an operating method for the image segmentation system 100. As shown in FIG. 5, the operating method includes the following steps:

Step S01 includes designating in an image preprocessing module an image stack from the plurality of image stacks as a first stack. In more definite terms, step S01 involves selecting in the image preprocessing module 10 a spatial level across the image stacks 52 as a first level (image stack). In the present embodiment, the image preprocessing module 10 of the image segmentation system 100 preferably has a default setting that indicates which spatial level it would like receive and process from the image data 50. Specifically, the image preprocessing module 10 will request to receive from the image data 50 the spatial level (image stack) that is in the middle of the 3D image scans 52. That is, the image preprocessing module 10 will designate a particular spatial level (image stack) as the first level L1 and request to receive from the image data 50 all images 53 that correspond to the first level L1 from all 3D image scans 52. However, in other different embodiments, the first level L1 designated by the image preprocessing module 10 may or may not be the exact middle spatial level in the 3D image scans 52. For instance, if there is an even number of images in the 3D image scans 52, any one of the two images that represent the middle two images in the 3D image scans 52 may be selected as the first level L1. In addition, it is the understanding that each 3D image scans 52 in the database 50 has exactly the same amount of images 53 as any other 3D image scans 52. However, the present invention does not make this a restricting factor. In other different embodiments, different image stacks 52 may have different amounts of images 53.

Step S02 includes transforming in the image preprocessing module the images for all stacks into binary images and generating object maps by detecting connected objects in the binary images. In the present embodiment, the image preprocessing module 10 transforms the raw (slide) images 53 in all image stacks into binary images. The image preprocessing module 10 may employ image contrasting, sharpening, or any other combination of image processing to transform the images 53 into the binary images. In this manner, as shown in FIG. 3A, the images 53 in (a) may be simplified to the binary image in (b) so that the amount of data needed to be subsequently analyzed by the motion analyzing module 20 may be reduced. Furthermore, in the present embodiment, the image preprocessing module 10 can generate object maps for each binary image 53 by detecting connected objects in the binary images 53. However, in other different embodiments, not all images 53 in all image stacks need to be transformed into binary images at the same time. For instance, the images 53 in an image stack may be transformed into their respective binary images as the image stack is being processed. In this manner, the processing resources may be reserved solely for processing the image stack that is currently being processed.

Step S03 includes analyzing in a motion analyzing module the binary images corresponding to the first level to find a repeating motion pattern, and accordingly generate a repeating motion result. In the present embodiment, the motion analyzing module 20 may include the spatial pattern detecting module 25 for recognizing structural (morphological) patterns in the binary images. However, in other different embodiments, the spatial pattern detecting module 25 may be an independent unit separate from the motion analyzing module 20. Preferably, the spatial pattern detecting module 25 runs a simplistic morphology-based algorithm that utilizes the layout, the shapes, the sizes, and the relative locations of discernible objects in the binary images to predict the locations of the left and/or right ventricle. That is, the spatial pattern detecting module 25 performs simplistic morphology pattern comparisons on the binary images of the 3D image scans 52 that correspond to the first image stack L1 in order to preliminarily identify potential objects that could possibly be the left and/or right ventricle. In the present embodiment, in terms of the heart as the object of interest, the image segmentation system 100 utilizes the spatial pattern detecting module 25 to first detect and identify the left ventricular structure of the heart. The spatial pattern detecting module 25 accordingly generates a recognition result based on this preliminary identification. The motion analyzing module 20 then compares the recognition results of each binary image in the first image stack L1 to detect or identify the movement or motion of each of the predicted potential left and/or right ventricle, as shown in FIG. 3D. In more definite terms, the motion analyzing module 20 utilizes the recognition results when comparing the consecutive binary images that correspond to the first level (image stack) L1 to determine a reoccurring or repeating (motion) pattern in the movements. In terms of the heart, the motion analyzing module 20 is looking for a periodic and cyclical cycle of motion by the potential left and/or right ventricle (that was found by the spatial pattern detecting module 25) as the binary images of the first level L1 is analyzed in chronological order.

Step S04 includes generating in a detection module a detection result of the first stack based on a frequency level of the repeating motion occurring within individual objects. In more definite terms, as shown in FIGS. 3D and 3E, the detection module 30 fuses the static information of the predicted potential left/right ventricle objects (recognition results) with the dynamic information of the repeated motion patterns (repeating motion result) to refine and select the potential left/right ventricle object having the highest frequencies of repeated motion patterns as the main left/right ventricle of the cardiac magnetic resonance images.

Step S05 includes generating in a classification module a classification result based on a spatial assumption and an anatomical assumption to classify the objects. In terms of the present embodiment, since the area of concern is on the heart, the spatial and anatomical assumptions correlate with assumptions on the structure, shape, size, and relative positions thereof of the heart. These assumptions are used to compare with the objects identified in the binary images (or object maps) to classify the individual objects as a category of the left ventricle or the right ventricle.

Step 06 includes generating segmentation results in a multi-dimensional detection module for the image stacks above and below the first stack according to spatial and temporal consistency of geometric layouts of the objects. As mentioned previously, the image segmentation system 100 has only performed segmentation processing on the first image stack L1 to find the precise locations of the left and right ventricles. Preferably, after identifying the left and right ventricles in the first image stack L1, the image segmentation system 100 will then use these results to find the corresponding left and right ventricles in the other spatial levels. As shown in FIG. 4, after the first image stack L1 has been processed, the results may be used to refine the prediction of the left and/or right ventricular structures in the above and/or below spatial levels (image stacks). For example, the locations of the left and right ventricles found after the image segmentation system 100 processed the first image stack L1 may be used as guidelines to find corresponding locations in the image 53 directly above or below the first image stack L1. The image segmentation system 100 can then once again process the images 53 in those spatial levels (image stacks), according to the process done in the first image stack L1, in order to once again accurately identify the left and/or right ventricular structures. The above process may be perpetually repeated for subsequent spatial levels (image stack) that are below or above. In this manner, by the time the image segmentation system 100 reaches the bottom most or the upper most spatial level, the left and right ventricular structures may still be accurately identified since their predicted locations correspond to the refined predictions found in the first image stack L1.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. An image segmentation system for segmenting image data having a plurality of image stacks ordered according to their respective spatial levels, wherein one image stack of the plurality of image stacks is designated as a first stack and each image stack has a plurality of images that are chronologically ordered, the image segmentation system comprising:
an image preprocessing module that transforms the images respectively into binary images and then transforms the binary images into connected object maps;
a motion analyzing module that generates a repeating motion result based on a repeating motion pattern of the binary images in the first stack;
a detection module that generates a detection result based on the repeating motion result and the object maps of the first stack;
a classification module that generates a classification result based on a spatial assumption and an anatomical assumption to classify objects in the object maps; and
a multi-dimensional detection module that generates segmentation results over the stacks above and below the first stack using spatial and temporal consistency of geometric layouts of object structures.

2. The image segmentation system of claim 1, wherein the spatial assumption is a layout relationship between a left ventricle and a right ventricle of a heart structure, the anatomical assumption is the circular geometry of the left ventricle, and the classification module classifies the objects in the object maps as a category of the left ventricle or the right ventricle.

3. The image segmentation system of claim 2, wherein the classification module classifies the objects of interest based on morphology of the objects of interest.

4. The image segmentation system of claim 2, wherein the refinement module compares objects of interest in binary images that correspond to the same chronological order that are respectively from two different but consecutive ordered image stacks, and accordingly generates a spatial image refinement adjustment.

5. The image segmentation system of claim 1, wherein the first stack is the image stack at the middle of the plurality of image stacks.

6. The image segmentation system of claim 1, wherein the images are magnetic resonance images of a three-dimensional structure.

7. The image segmentation system of claim 1, wherein the image preprocessing module transforms the images in the first stack into binary images.

8. The image segmentation system of claim 1, wherein the image preprocessing module transforms the images in each image stack into binary images.

9. The image segmentation system of claim 1, wherein the preprocessing module transforms the images into the binary images through image sharpening or image contrasting processes.

10. The image segmentation system of claim 1, further comprising a spatial pattern detecting module for recognizing structural patterns in the binary images and generating a recognition result based on the recognition.

11. The image segmentation system of claim 10, wherein the motion analyzing module compares the recognition results of each binary image in the first stack to find the repeating motion pattern and accordingly generates the repeating motion result.

12. The image segmentation system of claim 1, wherein the motion analyzing module utilizes motion history image processes, motion energy image processes, volumetric motion history image processes, or a combination thereof to detect motion between the binary images.

13. An operating method of an image segmentation system on an image data, wherein the image data has a plurality of image stacks ordered according to their respective spatial levels, wherein each image stack has a plurality of images that are chronologically ordered, the operating method comprising:
(A) designating in an image preprocessing module an image stack from the plurality of image stacks as a first stack;
(B) transforming in the image preprocessing module the images in the first stack into binary images;
(C) analyzing in a motion analyzing module for a repeating motion pattern in the binary images and accordingly generating a repeating motion result; and
(D) generating in a detection module a detection result based on the repeating motion result.

14. The operating method of claim 13, the step (B) further comprising:
(B-1) transforming each image of each image stack into binary images.

15. The operating method of claim 13, the step (B) further comprising:
(B-2) detecting connected objects in the binary images and accordingly generating object maps; and
(B-3) classifying the connected objects as a foreground and the rest as a background.

16. The operating method of claim 13, the step (C) further comprising:
(C-1) detecting movements between each two consecutive binary images; and
(C-2) computing the intersections among the detected movements as repeating motion patterns and accordingly generating the repeating motion result.

17. The operating method of claim 16, the step (D) further comprising:
(D-1) generating the detection result by classifying detected objects in the repeating motion patterns based on the morphology of each object according to shape, size, and relative locations thereof.

18. The operating method of claim 13, wherein after step (D) further comprising repeating steps (B) to (D) for each image stack in order of spatial level from the first stack.

19. The operating method of claim 18, wherein detection and classification results of prior image stacks is used to refine the detection and classification results of objects in the binary images of subsequent image stacks for spatial-temporal consistency.
